(19) United States
(12) Patent Application Publication
(10) Pub. No.: US 2004/0010511 A1
(43) Pub. Date: Jan. 15, 2004

(54) Method and system for drug utilization review

(76) Inventor: Victor V. Gogolak, McLean, VA (US)

Correspondence Address: KILPATRICK STOCKTON LLP, 607 14TH STREET, N.W., SUITE 900, WASHINGTON, DC, 20005, US

(21) Appl. No.: 10/192,659

(22) Filed: Jul. 11, 2002

(51) Int. Cl. G06F 7/00

(52) U.S. Cl. 707/104.1

(57) ABSTRACT

Conducting drug utilization review. The method comprising: collecting patient data, drug data, and practice data, normalizing the terminology of each data, and determining, from among the drugs identified by the drug data, each drug that addresses a patient's characteristics as defined in the patient data, and that meets the requirements of the practice data. The drug data contains information regarding at least the risk of adverse reaction to each drug, and rules for prescribing each drug.

### CROSS REFERENCE TO RELATED APPLICATIONS

Pending U.S. utility patent application Ser. No. 09/683828, entitled PROCESSING DRUG DATA and filed on Feb. 20, 2002 is hereby incorporated by reference in its entirety. Pending U.S. utility patent application Ser. No. 09/681587, entitled PHARMACOVIGILANCE DATABASE and filed on May 02, 2001 is hereby incorporated by reference in its entirety.

### FIELD OF THE INVENTION

The present invention relates to decision support generally. More specifically, the present invention relates to supporting a physician making a decision to prescribe one or more drugs to a patient.

### BACKGROUND

Drug utilization review (DUR) is a critical component of healthcare. Unlike drug safety, which involves U.S. Food and Drug Administration (FDA) review of drugs entering and already integrated in the market, DUR refers to the safeguards performed by physicians, and sometimes pharmacists, before deciding on and filling out a patient prescription. This involves more than just checking drug-drug interactions related to other medications the patient is taking. DUR involves checking other relevant information on the patient's current and past condition. With over 2.5 million adverse drug reaction (ADR) related hospitalizations (estimated) and 100,000 deaths (Institute of Medicine report) as well as $70 billion or more annually in costs to treat these ADRs, there is a clear need for improved prescribing practice at the point of care (POC).

Most computer-assisted drug utilization review (DUR) is typically after-the-fact, based on simplistic drug-drug interactions, and rarely considers the specific patient situation.

Even such a simple comparison as drug-drug interaction (not considering a specific patient) is not easily implemented as a computer-assisted activity due to multiple vocabularies employed across the pharmaceutical community. It is not simple for either a human or a computer program to look across drugs in the same therapeutic category to compare such items as the contraindications, warnings and precautions. Pharmaceutical companies write each label for the purpose of informing physicians of the particular issues with the company's drug. However, if one wanted to compare, for example, the listed warnings for similar drugs, uncomplicated rules could not be readily applied until the information was normalized to a common vocabulary.

Manual review of this voluminous data, given the diverse and often inconsistent nature of terminology used across labels, requires enormous amounts of time.

In addition, safety assessments are traditionally limited to a one-way pack of information on the drug (PDR, drug-drug interactions compendia, etc.), meaning there is little systematic focus on individual patient conditions and needs. In general, the routing and content of label information means to “push” the information in a one-way direction toward the physician. Pharmaceutical companies translate information on their drug labels, and the reports go to physicians. This inhibits physicians at the POC, for example, from introducing questions to the pharmaceutical companies concerning appropriate drugs based on a patient's condition.

Another challenge in POC drug review is the extraction of patient chart data, a process that is slow and difficult. All doctors keep medical records or their patients, but formats vary among physicians. Records may be electronic, simply word-processed, in one of many existing software formats (e.g. Allscripts, Coderite etc.), or possibly hand-written.

Another driving issue of DUR at the point of care is time. When combined with the volume of information, drug assessment at POC puts tremendous pressure on healthcare providers.

Today, the prescription POC systems do not allow quick or easy reference on: labeled contraindications, warnings and precautions; actual adverse event data from both clinical trials and from post-market reporting; new labels or drugs; or association with a specific patient profile. There are no systems that prepare or anticipate the possible situations that could arise given a patient's condition, and follow-up remains largely executed via manual intervention (call from a lab, calls by PBMs etc.). However, the POC is the best time to use this information to account for the immediate patient situation to provide easy to use information on drug safety and warnings to physicians at the time and point of service.

### SUMMARY OF THE INVENTION

The current invention addresses the shortfalls of systems that fail to provide vital data before, during, and after the point of care. It includes prepared drug label and patient-specific information that anticipates POC situations. Preferred embodiments of the present invention provide a unifying structure and standard set of dictionaries for key categories of information (e.g. reactions, drugs, indications, etc.) to make patient history and drug data more comparable. In addition, such embodiments extract important types of information from the label and present the extracted information in order of greatest relevance to the DUR. This latter point is critical, since many items handled on a label are of information only, or are of relatively minor consequence and/or of relatively infrequent occurrence. This triage method, using well-defined lists rating adverse event severity, such as those defined by the FDA, DMF, or the physician, reduces time pressure and focuses physicians on critical questions relevant to prevent serious adverse events for a specific patient. Some embodiments of the invention compare label and other information, e.g., literature with specific patient condition as well. In addition, some embodiments are aware, through the information structure of the invention, of each of the types of information that are required to fully address the patient's situation. In some cases the label indicates that the physician should instruct the patient to watch for possible reactions to the drug, and based on severity, to take certain actions. Using label information at this level of detail at the POC has been unknown, prior to the present invention. Preferred embodiments provide a standard structure and set of dictionaries for certain categories of information, e.g., reactions, drugs, indications, etc. that allows patient data to be stored, retrieved, and compared with label and other drug safety and rules-based information.

The current invention includes a method embodiment to provide drug evaluation at two points:

when the physician prescribes medication, and

when the patient is ready to take the medication.

The current invention, in several embodiments, is a combination of prepared patient medical data relevant to drug therapy and drug label information, relevant to the patient; all driven by prioritized set of criteria that aim to reduce the likelihood of serious negative outcomes. Some embodiments of the method use all these prepared modules, though in some circumstances, a select subset could be used.

Some embodiments overcome the need to review tens or hundreds of items at the point-of-care (POC) by pre-preparing against the most serious outcomes. These embodiments provide a method to triage information needed, based on seriousness and on a set of rules in the physician's control.

### DESCRIPTION OF THE SEVERAL VIEWS OF THE DRAWING(S)

FIG. 1 illustrates both the structure and process of preferred embodiments of the present invention.

FIG. 2 illustrates, in an alternate fashion to FIG. 1, the structure and process of preferred embodiments of the present invention.

FIG. 3 is an exemplary illustration of one implementation of a preferred embodiment of the present invention.

FIG. 4 is an alternate illustration of one implementation of a preferred embodiment of the present invention.

FIG. 5 us an alternate illustration of one implementation of a preferred embodiment of the present invention.

### DETAILED DESCRIPTION OF THE INVENTION

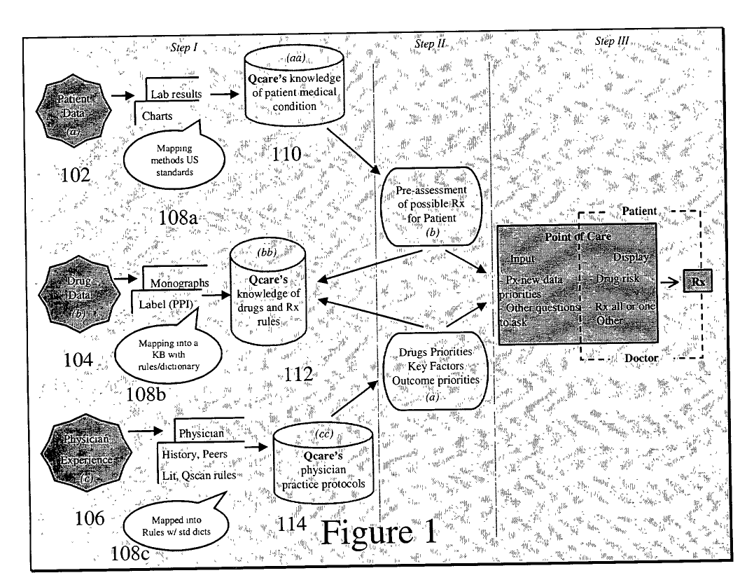

Referring to FIG. 1, preferred embodiments of the invention combine patient data 102, drug label data 104, and physician input 106 (including prescribing rules) in an efficient, computer-based artificial intelligence system (including expert systems, fuzzy logic, neural networks and case-based reasoning algorithms) with a variety of options for input and output. The use of multiple artificial techniques is a component of some embodiments because those embodiments capitalize on the best and most appropriate use of each technique. For example, neural networks can parse great volumes of data, but many need to be performed off-line, whereas expert systems, based on logical rules, can be quickly calculated. The use of “fuzzy logic” is appropriate where there are user-defined ranges to be considered, such as the determination of what constitutes “elevated” in the case of an individual patients blood pressure. With fuzzy logic, a physician can use a heuristic approach, based on his experience with this patient. Similarly, if a label uses the term “elderly,” the invention may use a combination of doctor experience and general clinical practice to define “elderly.” In the preferred embodiments, patient data 102 (including patient historical data) is parsed and mapped to be compared with the kind of information relevant to drug labels. For example, drug labels speak in terms of disease history and current patient condition using a variety of vocabularies. The current invention, using a thesaurus/dictionary combination 108a, 108b, 108c can bring the patient data 101 and the drug label data 104 under a common (user-defined) vocabulary using e.g. Stedman's, Dorland's or Mosbey's or other standard medical dictionaries. The process of bringing data of diverse, potentially ambiguous, terminology under a common vocabulary can be referred to as normalization.

Another component of some embodiments is the POC information provided by the physician 106, i.e., practice data. Those embodiments, knowing the potential drugs considered (previously entered by the user, or selected rapidly at POC) uses a drug label database 112 along with the physician protocols (that is, protocols or approaches that are based on the physician's experience). These are used to complement data on labels 104 to compare with the specific parsed and mapped patient record 110, in order to suggest questions related to previous problems with drugs, family history, or reactions with related drugs.

In a preferred embodiment, the efficient use of handheld computer systems, on-screen as well as voice recognition, and the presentation of medical data in visual structures that are intuitive, can all be used at the POC, depending on the specific clinical situation (in-patient, out-patient, field etc.).

To support the variety of ways a physician might plan a therapeutic approach to a patient, the invention, in some embodiments, considers two modes of considering drugs:

Review of several candidate drugs (e.g. searched for by therapeutic category), specifically those likely to have lower ADRs for this patient.

Check all adverse outcomes for a selected drug.

To accomplish this rapidly, those embodiments use a structured version of the information from drug labels 112 that facilitates the calculation of statistics, the performance of comparisons, and especially the application of rules. Rules are the heart of drug labels; when to use or not use a drug, what instructions to provide the patient, what follow-up or monitoring is necessary.

In general labels provide two kinds of information: facts and rules.

Facts on indications, dose, adverse events etc that are not imperatives or suggestions, but provide the prescribing physician with the information he need to make decisions on his diagnosis. This area largely focuses on the efficacy of the drug, as indicated for the therapy the physician desires for the patient. These data were derived typically in the clinical trials, largely focusing on adverse reactions. Rules provide a guide to the physician on whether to prescribe the drug for the given patient. These are contained primarily in the contraindications, warnings and precaution sections of a label (The adverse event section is not prescriptive, but only alerts the physician to the frequency of certain events. So for a person particularly affected by headache, if headache is more frequently seen than he would like for his patient, then the physician might look for an alternative drug).

With parsed and mapped information on patients 110 and labels 112, the invention applies several artificial intelligence techniques to “fire” the label rules to produce the “consequent” or conclusions. These well-founded tools are applied in some embodiments based on a set of therapeutic-area-specific protocols developed with experts. The experts have encapsulated years of experience into a set of protocols that compare patient and drug labels.

The results, for either the drug therapeutic category cases (select among several options) or the drug select case (check for the safety of a selected drug) supported by the invention, are displayed for the physician.

Based on protocols, there may be serious gaps in information that make a suggestion of best drug or an assessment of a given drug difficult. To make an informed decision preferred embodiments suggest other questions that the physician could ask or that the physician could otherwise determine, in order to rule out certain risks. These questions are presented, the patient is asked or the physician checks a condition, and the data is quickly and easily entered using standard medical vocabulary. In these embodiments, this interaction is quick, based on a triage of the many questions driven by a list of outcomes (e.g. the FDA's Designated Medical Events). Also, the data entered is often via pull down choices, so there is no need for keyboard entry or reference lookup.

After the POC interaction, and using the factor of uncertainty as well as the fixed rules, the invention provides information for prescribing for the patient. Once a drug has been selected by the physician as a possible drug for the patient, the preferred embodiments of the current invention then link to other information on a proper dosing (e.g. based on age, sex, weight, etc) and suggests tests that may be needed to monitor progress of the patient. As a follow-up, the physician version of the invention provides a means to add new data and, using rules set up by the physician, will alert to new risks or the elimination of prior risks.

Preferred embodiments of the invention take advantage of the triage potential within drug labels. By focusing on potential outcomes, in descending order of severity, the number of items to check before prescribing can be reduced from hundreds, to a few key items. Because patient information 110 exists in the database in parallel to the physician 114 and drug label rules 112, those drugs showing adverse outcomes against a patient profile, may be eliminated without any effort by the physician at the POC. In cases where an extremely large number of outcomes are possible, the physician may employ another feature; they can assess risk based on percentage experience in the clinical trial (often available on the label), or from post market experience. One of the advantages of some embodiments of the invention is the consideration of data ancillary to the label, such as post market ADR reports, where there is evidence that a particular ADR is occurring at a higher frequency than expected. The uses of these risk levels are, of course, at the discretion of the physician.

For example, although there are several types of detailed rules that result from the Celebrex™ label, there are relatively few serious outcomes mentioned:

Gastrointestinal bleeding, with potentially fatal results

Anaphylactic reaction

Present or past patient conditions that indicate the possibility of gastrointestinal bleeding with the use of Celebrex can be checked invention prior to patient contact. Deciphering a patient's vulnerability to an anaphylactic reaction, however, may require the physician to ask the patient for supplemental data at the POC in order to eliminate or confirm the anaphylactic risk. In some cases, patients may not know what an anaphylactic reaction is, so the physician would need to inquire after certain symptoms of such a syndrome to determine whether the patient did or did not have such a reaction.

In other cases, Celebrex has an advantageous ADR profile compared with the other drugs in the non-steroidal anti-inflammatory drug (NSAID) class. Vioxx is another COX-2 inhibitor, similar to Celebrex, but without the sulfonamide-related contraindication however, there are certain situations when may be more Celebrex advantageous over Vioxx given certain concominant drugs, or if cost, availability, or efficiency for the patient were considered, the physician could make an informed decision for either Vioxx or Celebrex.

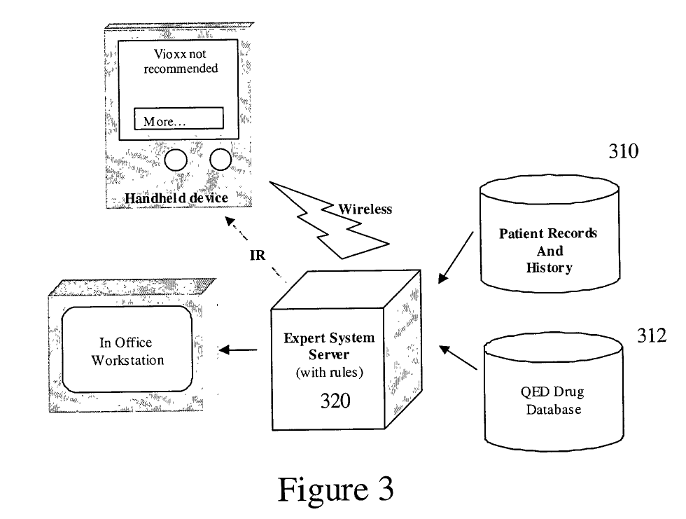

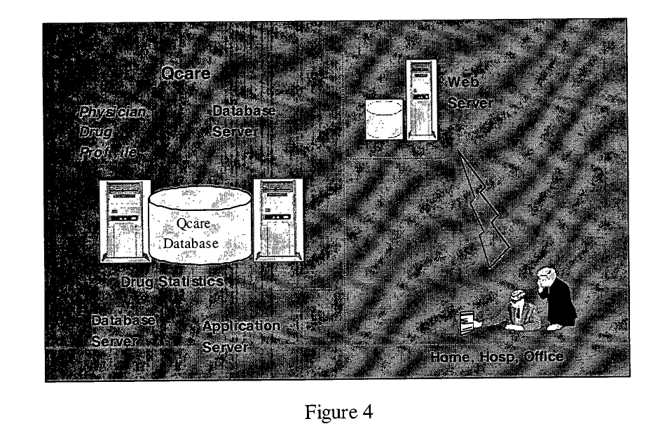

In preferred embodiments, the invention is an expert system that supports physician decision-making at the POC using a combination of data, expertise and a POC device (handheld or PC) to provide the physician with data he needs to judge proper medication. FIGS. 3 and 4 provide overviews of the those embodiments of the invention.

The invention, in preferred embodiments, standardizes the most frequently prescribed medications to a database 312 that can be compared to clinical information in the patient medical record 310 and other information determined at POC. Physicians will enter any new information at time of service, and select either a therapeutic category or a planned medication. Preferred embodiments will check patient medial records 310, including their condition and history and entries at the POC, and the drug label information 312, and by using rules from the drug label and rules provided by experts and physicians 114, will indicate appropriate drug(s), possible safety issues, and other clinical protocols that the experts devise (both drug and non drug related best practices). Prescriptions can be capture then or entered later. Both preliminary screening of the most serious adverse reactions, and the option to explore and compare the less severe adverse effects of possible drug selections are offered by embodiments of the invention. This check can be made before filling a prescription, or to note special considerations (e.g. liver function tests). Some embodiments of the invention allow a user to define “serious” and other similar terms. FIG. 1 illustrates this process.

In preferred embodiments, the invention incorporates three sources of data into central database 110, 112, 114, shown in FIG. 1. Patient Data 102, may include a patient's medical history in the form of charts and lab results as well as patient current condition (entered at POC). Drug Data 104 includes drug label information, as well as information from monographs. Physician Experience 106 incorporates an individual physician's rules of practice derived from many sources, including past knowledge, peers, literature, and other rules. Area specialists may provide physicians with these protocols or “rules” (e.g. A group of Rheumatologists that are respected across their field for indicating best medical approach given the available information).

Preferred embodiments of the invention store the three rules-based and fact-based databases mapping these to standard sources: the system's knowledge of patient medical condition 110, knowledge of drugs and prescription rules 112, and physician practice protocols 119. The system then calculates and filters requested information using these rules. Physicians may solicit information about one or more drug's compatibility with a given patient profile. Rules and facts defined within and among the Drug Data, Physician Experience, and Patient Data determine prescribing information for the physician.

Incorporated within the database are:

A set of rules that relate and sort data from the three sources cited above, e.g., 320—Rules existing within the database, before patient records are entered, come from drug labels and monographs and physician experience. Drug label data 104, extracted from FDA approved labels, contains: contraindications, warnings, precautions, dosage etc. for a given drug. Post-approval monographs 104 that contain new drug safety information not yet incorporated in a label change, also reside in the database. Physician experience 106 provides individualized rules based on physician practice and preferences. Database output is based on physician practice protocols, drug priorities, outcome priorities, and key factors concerning patient care.

Standard dictionaries that provide common vocabulary among and within the three sources of data 108—The standard dictionaries and thesauri endeavor to maintain validity within the database rules even where vocabulary among the three sources differs. An example may be useful. A Vioxx™ label may say that if a patient had a reaction to an NSAID, the drug is “contraindicated.” Another label may say “do not prescribe” the drug for patients with a history of renal problems. “Contraindicated” and “do not prescribe” would, in this case, be the thesaurus terms linked to a common term/phrase, e.g. “DO NOT PRESCRIBE”. “Contraindicated” and “do not prescribe” are the verbatim and the common term/phrase “DO NOT PRESCRIBE” the “map to”. The “map to” term is used to describe the standard term that invention uses to make the information from natural language sources understandable to automated systems.

Another feature of some embodiments is the ability to map terms within the possible rules in the contraindications, warnings, and precautions sections on a label, to a standard set of common terms. The physician regularly uses these to decide on the appropriateness of the drug for a patient. The invention matches facts about medical aspects of the patient and compares them in a medically significant way, with the information on a drug label. The rules backbone allows a simple query of the database to perform the following function: List all drugs that should not be presented if the patient has a history of certain problems. The process of incorporating patient information into the database, in order to calculate outcomes based on drug and physician-based rules, involves three main steps (see Parts I, II, and III of FIG. 1)

Step 1: Integrating Database Sources. The initial step of integrating the databases in preferred embodiments of the invention involves a set of standardized elements for each information source. Patient Data 102, likely entered into a central, local workstation in the physician office includes:

information about patient schedule information (for the physician's office to know on which patient charts to perform preliminary safety scans that physicians may use as quick references at the POC);

the format of the patient record (arrangement and choice of fields, possible medical record systems in use such as Coderite);

access to patient record info such as: patient demographic (coded to blind the data for privacy reasons), history, family history, drugs, reactions, indications, current condition, diagnosis etc.;

protection of patient privacy; and

mapping to standard dictionaries and thesauri to provide a common vocabulary among databases (mapped terms remain consistent throughout the database).

Drug Data 104 includes a collection of pre-market clinical trial adverse events and post-market ADR data from a variety of sources, but preferably including the latest available public information on all post-market Adverse Events (AE's) and label changes. This information would be downloaded at a convenient time to augment the label information on the drugs, and provide the physician with added value and knowledge of the drugs he regularly prescribes—the data on the drugs behavior after it has been on the market. In preferred embodiments, drug information enters the database via a main server. Information on warnings, contraindications and adverse reactions from the label include:

recent drugs and label changes

recent adverse event information compared to background (post-market clinical trials); and

pertinent information from literature (medical journals, compendia, etc).

mapping into a knowledgebase with rules linking to dictionaries and thesauri in order to provide a common vocabulary among databases

Physician Experience 106 allows physicians to design individualized rules determining:

how to compare patient condition and history with contraindications, warnings, and precautions. (Preferred embodiments of the system provide the ability to augment or block the implementation of certain rules in the expert system.);

how to use drug interaction information, labeled and post-market adverse event data. (Physicians can choose what post-market information to implement, thereby accepting some data as relevant and ignoring other.);

how to match condition to preferred therapeutic approach. (For example, a physician may look first at Celebrex for their elderly arthritis patients, before considering other anti-inflammatory drugs.);

expert (other recognized physicians') point-of-care protocol or information;

how to physically capture point-of-care data on the system.

Physicians may promote or de-emphasize aspects of the POC interface, to cater to their personal style. For example how to present patient history/condition and results of rule application (e.g. warn of precaution, recommend alternate medication, etc?). For example, a physician may want an automatic comparison with Celebrex anytime he or she considers NSAID therapy.

These physician rules are also mapped into the standard dictionaries and thesauri to provide a common vocabulary among all three databases. Physicians establish these rules in the database before it becomes operational, but may choose to update these rules. The three databases 110, 112, 114 contain these elements in a form in which the expert system can sort through.

Step 2: Pre-assessment and analysis of Patient within the system.

The day before patient's visit (or some other time prior to POC), the physician's office refers to charts for patients visiting the following day (date according). Patient charts and lab results not already existing on the database (e.g. new patients) may be added prior to, or at time of visit. In the preferred method, physicians execute a preliminary assessment of possible prescribed drugs against a patient's history before each visit. Some physicians can choose to forego this preliminary check, however.

In addition, the physician rules database of the invention includes the individual physician profile to include top drugs used, top reactions, therapeutic alternatives, and parameters of interest to display. The preferred version of invention may also be specialized for specialty areas. For example, if a rheumatologist only prescribes a selected assortment of drugs, the database compares only this set of drugs with the rheumatologist's patient record. Therefore, using a knowledge base of drug label and physician rules, the initial analysis screens for drugs that yield the most severe adverse reactions for a given patient profile, or alternatively, show those drugs that have the least level of some selected set of reactions. The search can also highlight for the physician, those therapies that present the lowest risks. This pre-screening can signal those drugs that have serious (as defined by the physician, using standard vocabulary) adverse reactions and contraindications for usage, given the patient profile. In addition, the Drug and Physician rules databases are updated on the server when label updates or other monographs emerge publicly. A system of the present invention may be implemented in several ways to take advantage of both then patient as well as the physicians experience and knowledge. In the case of the physician, there is a follow-up use of the system based on possible tests or new data. In addition, a publicly accessible, but privacy protected version of the system allows the patient to provide backup information using the system to walk the patient through a set of questions in the system. In this case, the set of actions, rather than being related to prescribing, would instruct the patient, e.g., to notify the physicians, or in some cases to seek medical help.

Step 3: Making decisions at the Point-of-Care (POC). At the POC, the physician determines information, either based on his normal practice, or suggested by the invention's pre-assessment information, needed to complete the picture of the patient situation and to ensure the best assessment.

The physician, or other user, refers to a local laptop, personal palm pilot etc., and possibly a computer printout), and enters new patient information in the database acquired at the POC including: patient data for certain fields that are appropriately entered at POC (e.g. blood pressure, that day), patient symptoms, medications the patient has begun since last visit (prescribed from another medical source, over-the-counter drugs), reactions to current medications, test results, or other physician notes. This information is used to ensure an currency of the analysis, as new patient information may alter the pre-assessment data. Once the patient profile is up-to-date, a search through the rule base provides the most current information. At the POC, the physician, or other user, uses POC data in the form of a convenient device with browser-like interface. That is, the database server links to a palm or pocket PC system, laptop, practice desktop, or similarly appropriate device for the physician's office environment.

When a physician determines the appropriate action to take, prescribing possibilities may be assessed in the database via at least two search modes.

First, a physician, or other user, may select a single drug to compare to a patient's data 110 in accordance with the physician's experience and practice protocols 114. Based on the established rules within the expert system, risk results for a single drug appear in one of at least three forms.

an Indication that drug is ok to prescribe;

an Indication that drug is not ok to prescribe—due to adverse event related in patient data and drug data, or conflict with physician protocol; and

a Prompt to the user with questions to ask questions the patient (these are provided on the interface) in order to supplement current information.

This last bit of information is used to further focus system output and complete the assessment of serious risks, as previously defined. The questions that the assessment provides, attempt to provide the physician with a more complete patient profile for making informed decisions for care. If there are rules in the system that require information not found in the patient profile, the system signals the doctor via “questions to ask patient” to fill in the missing data. This process seeks a high level of patient safety, yet allows physician discretion as to information he asks for.

Single drug selections also provide warnings, instructions, and adverse events, from both the label and post market information about the drug. These guide the physician in follow-up actions, if the drug is prescribed.

The physician asks for a list of drugs in a therapeutic class that presents comparative data on drugs in that category, based on the physician's areas of interest. Based on the established rules within the expert system, risk profiles for an array of drugs appear in one of three forms:

listing of drugs prioritized by lowest risk for the given patient. The FDA does provide defined levels of risk and adverse event severity, but physicians have the option to create their own risk categories within the physician rules database. Preferred embodiments of the system assesses risk by comparing the specific patient record information against the rules for prescribing the drug. This provides an assessment for that patient among the various drugs under consideration.

indication that no drugs under this category are safe for this patient (Note that drugs have been pre-screened against patient data to rule out those causing serious adverse events or contraindications)

prompt to ask questions (these are provided on the interface) to gain more information on the patient—the given information is not sufficient to perform complete assessment

The invention also has the potential to process and present the following items to the physician:

key differences in ADRs given demographic, sex, or age information;

difference in Adverse Event rates for similar drugs and for certain reactions (e.g. where a patient is particularly sensitive);

on-line electronic prescribing (with appropriate electronic signature or other approved validation techniques);

new drugs, not yet in PDR or AHFS or USPDI;

literature data on key drugs published in medical journals and compendia;

links to complete label information; and

links to specific text in the labels that triggered the specific rules leading to the information about the drug risks for the patient.

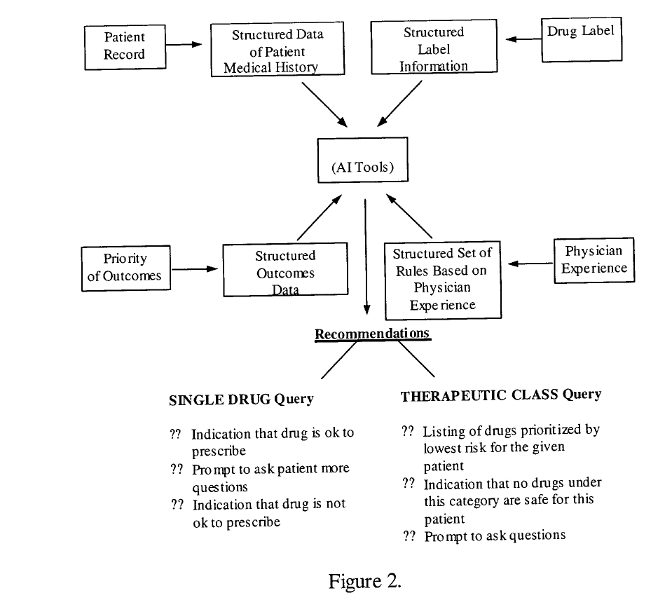

The final prescribing decisions and practices remain at physician discretion. FIG. 2 illustrates schematically how Steps 1, 2 and 3 come together as the a preferred embodiment of the invention.

At times there are circumstances that require follow-up work, e.g., lab work or radiology. The impact of the findings from such work on drug decisions can be significant. Preferred embodiments of the present invention provide a means to revise the above-described results based on follow-up activities. Most drug utilization review is done for formulary and cist checks. Some alert after the fact to drug interactions, and lead to costly switches. Some in-house hospital practice and out-patient practice provides a check on certain lab results; but this is typically done manually. Preferred embodiments of the present invention, having data and decision models on-line, can revise the analysis with new follow-up data. For example, suppose the patient was prescribed a typical NSAID based on cost, but follow-up for stomach pain shows gastrointestinal bleeding. The physician, after revising the analysis using an embodiment of the present invention finds that there was no allergic reaction to sulfonamides and therefore prescribes another drug, e.g., Celebrex™.

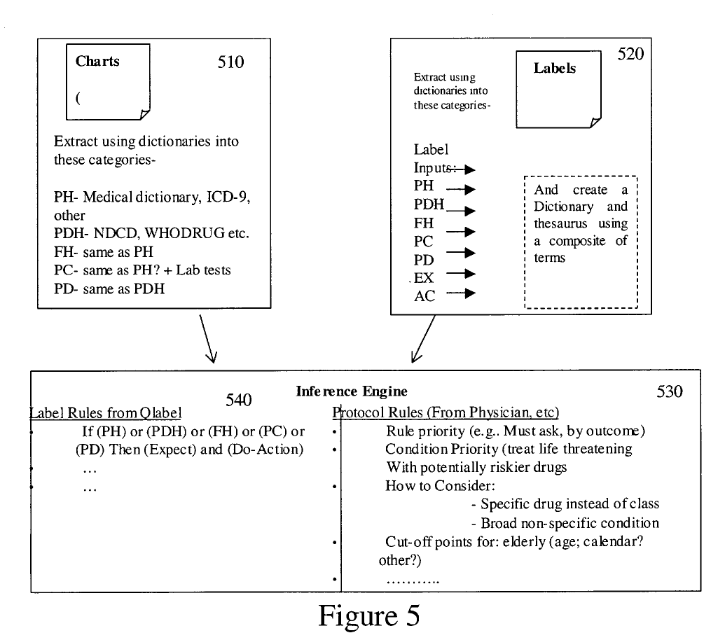

Referring to FIG. 5, a further illustration of a preferred embodiment of the present invention is shown relating patient data 510 (using chart data as an example), drug data 520, and practice data 530, along with an inference engine 540. Patient data can include patient history (PH), patient drug history (PDH), The inference engine 540 uses structured rules 540 derived from the drug data 520 and practice data 530. These structured rule 540 are populated with normalized patient data 510, e.g., patient data linked to one or more dictionaries of common medical terms. The ability of the inference engine, or other expert system such as a neural network to reliably determine the consequence of the inputs depends on the harmonization of terminology achieved by linking the verbatim drug data and verbatim patient data to a common set of terms.

The approach illustrated in FIG. 5 is useful at different times in the process, e.g.:

before POC, to anticipate the drug prescribing decision so that there are indications of the patient's sensitivities or to alert the physician to ask key questions that relate to triaged adverse event risk;

at the POC, to account for new information directly from a patient (e.g., at a kiosk), new information solicited by a nurse, or observations of a physician—each used to update the risk profile for the patient; and

after the POC, adding information on follow-up recommended by embodiments of the invention, e.g., a liver function test—and rerunning the revised data against the rules.

I claim:

1. A method for conducting drug utilization review, the method comprising:
collecting patient data, drug data, and practice data,
the drug data containing:
information regarding at least the risk of adverse reaction to each drug, and
rules for prescribing each drug;
normalizing the terminology of each data; and
determining, from among the drugs identified by the drug data, each drug that addresses a patient's characteristics as defined in the patient data, and that meets the requirements of the practice data.

2. The method of claim 1 wherein determined drugs are presented in order of risk of adverse reaction.

3. The method of claim 1 wherein determining, from among the drugs identified by the drug data, each drug that addresses a patient's characteristics as defined in the patient data, and that meets the requirements of the practice data comprises:
identifying to a user, at least one element of data missing from the determination analysis.

4. The method of claim 3 wherein determined drugs are presented in order of risk of adverse reaction.

5. A method for conducting drug utilization review, the method comprising:
collecting patient data, drug data, and practice data,
the drug data containing:
information regarding at least the risk of adverse reaction to each drug, and
rules for prescribing each drug;
normalizing the terminology of each data; and
determining, for at one subject drug among the drugs identified in the drug data and considering the practice data, an estimate of the appropriateness of each subject drug for the subject patient.

6. The method of claim 5 wherein determining, for at one subject drug among the drugs identified in the drug data and considering the practice data, an estimate of the appropriateness of each subject drug for the subject patient comprises:
identifying to a user, at least one element of data missing from the determination analysis.
